(19) United States
(12) Patent Application Publication
(10) Pub. No.: US 2005/0117181 A1
(43) Pub. Date: Jun. 2, 2005

(54) Film image scanning system and light source unit for scanning a film

(75) Inventor: Hayato Hokoi, Sakura-shi (JP)

Correspondence Address: OLIFF & BERRIDGE, PLC, P.O. BOX 19928, ALEXANDRIA, VA, 22320, US

(73) Assignee: NIKON CORPORATION, Chiyoda-ku (JP)

(21) Appl. No.: 10/899,118

(22) Filed: Jul. 27, 2004

(30) Foreign Application Priority Data
Aug. 8, 2003 (JP) 2003-206738

(51) Int. Cl. H04N 1/21

(52) U.S. Cl. 358/302; 358/483

(57) ABSTRACT

When scanning a film image, a difference in sensitivity between image planes corresponding to respective colors of light caused by color CCD filters is eliminated, and resolution and dynamic range of the scanned image are greatly improved. Therefore, the system includes: a light source unit for scanning a film, which emits light of a plurality of narrow bands toward a film as a single band or in a combination thereof; a digital camera scanning the light transmitted through the film with a color CCD, producing an image plane of each color of the light based on output data from the color CCD where each color of the light has been subjected to a sensitivity correction, and producing a film image by combining the respective image planes produced; and a controller connected to the light source unit and the digital camera to control the light source unit and the digital camera.

### BACKGROUND OF THE INVENTION

1. Field of the Invention

The present invention relates to a film image scanning system and a light source unit for scanning a film. More specifically, the present invention relates to a film image scanning system and a light source unit for scanning a film suited for photographing a negative film or a positive film by a digital camera or a TV camera equipped with a color area CCD.

2. Description of the Related Art

It is convenient if a digital camera or the like can be used for easily and quickly capturing film images to be posted on the WWW (World Wide Web). However, when the digital camera or the like captures the image by irradiating the film with white light source, a conventional system is hard to obtain a high image quality that can satisfy users in view of the resolution and the dynamic range (reproducible tonal range).

A technique for photographing a negative or positive film by an electric camera is disclosed in Japanese Examined Patent Application Publication No. Hei 7-38725.

In conventional arts, when using a digital camera with a color area CCD to photograph a film by white light source irradiation, there exist problems as follows:

Firstly, a color filter for color separation is provided in front of the color area CCD. As a color filter, the Bayer array color filter is well known. For example, in case of an RGB primary color filter, light transmitted through the color filter will be R (Red) light, G (Green) light, and B (Blue) light. Therefore, on the acceptance surface for each pixel of the color area CCD, R light transmitted through the R filter, G light transmitted through the G filter, or B light transmitted through the B filter is incident. In view of this, among the incident light on each acceptance surface of the color area CCD, light other than the transmitted light (for example, the B light and G light in case R is the transmitted light), is weakened because of the disposition of the color filter, thereby decreasing the intensity of received light. Therefore, an interpolation processing is needed, and the image will lose its sharpness. Furthermore, the film color separation is different from the spectral characteristics of the CCD and the white light source. When the color is reproduced, the image loses its original saturation.

Secondly, AE (automatic exposure) control is not optimized for film scanning and therefore, a problem occurs in view of S/N. For example, it happens that a necessary dynamic range for precisely reproducing an image in the shadow area of the film (the dark area of the film image) cannot be ensured.

According to the above first and second reasons, when a film is scanned with a white light source, a color separation performance of a general color area CCD is not optimal for film scanning in terms of resolution, color tone, and density separation.

### SUMMARY OF THE INVENTION

An object of the present invention is to provide a film image scanning system and a light source unit for scanning a film, which are capable of greatly improving the resolution and the dynamic range of a film-scanned image, in spite of using a color CCD or the like that is hardware such as a conventional digital camera or the like.

In order to attain the above-mentioned object, according to a first aspect of the invention, a film image scanning system includes: a light source unit for scanning a film, which emits light of a plurality of narrow bands toward a film as a single band or in a combination thereof; and an image input apparatus scanning the light transmitted through the film with a color CCD, producing an image plane of each color of the light based on data from the color CCD where each color of the light has been subjected to a sensitivity correction, and producing a film image by combining the respective image planes produced.

According to the first aspect, the wavelength range of three-color-separated light beams is set to be located in an area where the wavelength range is sensitive to both a film dye (C, M, Y) and the crosstalk region of color channels of CCD spectral characteristics. Therefore, the film image can be read in after the difference in sensitivity of the color filters provided in the color CCD is corrected for each color of light.

According to a second aspect of the invention, the system of the first aspect is characterized in that the image input apparatus preferably includes a control unit controlling operations of the light source unit and the image input apparatus itself.

According to a third aspect of the invention, a film image scanning system includes: a light source unit for scanning a film, which emits light of a plurality of narrow bands toward a film as a single band or in a combination thereof; an image input apparatus for scanning the light transmitted through the film with a color CCD, producing an image plane of each color of the light based on data from the color CCD where each color of the light has been subjected to a sensitivity correction, and producing a film image by combining the respective image planes produced; and a controller connected to the light source unit and the image input apparatus so as to control the light source unit and the image input apparatus.

According to a forth aspect of the invention, the system of the first or third aspect is characterized in that the color CCD is preferably a color area CCD.

According to a fifth aspect of the invention, the system of the first or third aspect is characterized in that the color CCD is preferably a color linear CCD.

According to a sixth aspect of the invention, the system of any one of the first to fourth aspects is characterized in that the image input apparatus is preferably a digital camera.

According to a seventh aspect of the invention, the system of any one of the first to fourth aspects is characterized in that the image input apparatus is preferably a TV camera using a color area CCD.

According to an eighth aspect of the invention, the system of any one of the first to seventh aspects is characterized in that the light source unit preferably emits infrared light singly or in combination with another narrow-band light.

According to the eighth aspect, it is possible to correct defects on the surface of the film by using the infrared light at high quality and speeds.

According to a ninth aspect of the invention, the system of any one of the first to eighth aspects is characterized in that a gain in accordance with the color of the light emitted from the light source unit and a type of a filter provided in the color CCD is multiplied by an output from the color CCD.

According to a tenth aspect of the invention, the system of the ninth aspect is characterized in that the gain is preferably stored as a table in a memory.

According to an eleventh aspect of the invention, the system of any one of the first to seventh aspects is characterized in that an amount of exposure is preferably adjusted in accordance with the color of the light emitted from the light source unit and a type of a filter provided in the color CCD.

According to a twelfth aspect of the invention, the system of any one of the first to seventh aspects is characterized in that light emission and exposure are preferably performed a plurality of times for each color of the light in accordance with the color of the light emitted from the light source unit and a type of a filter provided in the color CCD.

According to a thirteenth aspect of the invention, the system of any one of the first to twelfth aspects is characterized by further including a printer printing the image having been read in by the image input apparatus.

According to a fourteenth aspect of the invention, a light source unit for scanning a film includes: a light-emitting unit emitting light in a plurality of colors; a diffusion device which diffuses the light from the light-emitting unit evenly toward a film; and a film holder holding the film.

According to a fifteenth aspect of the invention, the light source unit of the fourteenth aspect is characterized in that the light-emitting unit preferably includes LEDs each having a different color (including an LED emitting infrared light), a fluorescent tube with an interference filter, or a halogen tube with an interference filter.

According to a sixteenth aspect of the invention, the light source unit of the fourteenth aspect is characterized by further including a color negative mode for performing exposure with an increased light amount of exposure or an increased amount of exposure of green and blue colors out of the colors of the emitted light.

According to the present invention, the RGB wavelength (narrow band) of the light source unit that emits light toward the film is located in the vicinity of the film dye (CMY) and the cross point of each spectral distribution of the filter of the CCD. Therefore, it is possible to enhance the resolution of each color plane, to greatly improve the dynamic range by reserving the S/N of each image data which is read in after being subjected to color separation, to eliminate the difference in sensitivity of each color image plane caused by the filter provided in the color CCD, and to combine the film images together.

In other words, the present invention provides a film image scanning system and a light source unit for scanning a film, which can greatly improve a resolution and a dynamic range of a film-scanned image, in spite of using a color CCD that is hardware such as a conventional digital camera or the like.

### BRIEF DESCRIPTION OF THE DRAWINGS

FIG. 1 is a schematic view of a first embodiment according to the present invention;

FIG. 2 is an explanatory view showing a CMY complementary color filter;

FIG. 3 is a view showing spectral characteristics of the CMY complementary color filter as shown in FIG. 1;

FIG. 4 is a view showing the spectral characteristics of an RGBLED light source (light source unit);

FIG. 5 is an explanatory view showing a primary RGB color filter;

FIG. 6 is a view showing the spectral characteristics of the primary RGB color filter of FIG. 5;

FIG. 7 is a flow chart showing an operation of the film image scanning system shown in FIG. 1, which includes a light source unit, a digital camera, and a personal computer;

FIG. 8 is a flow chart showing an operation of the film image scanning system shown in FIG. 1, which includes a light source unit, a digital camera, and a personal computer;

FIG. 9 is a flow chart showing an operation of the film image scanning system shown in FIG. 1, which includes a light source unit, a digital camera, and a personal computer;

FIG. 10 is an explanatory view showing an image composition when using a complementary color filter;

FIG. 11 is an explanatory view showing an image composition when using a complementary color filter;

FIG. 12 is an explanatory view showing an image composition when using a complementary color filter;

FIG. 13 is a schematic view of a second embodiment according to the present invention;

FIG. 14 is a schematic view of a third embodiment according to the present invention; and

FIG. 15 is an explanatory view of an embodiment of the light source unit according to the present invention.

### DESCRIPTION OF THE PREFERRED EMBODIMENTS

Embodiments of the present invention will be described hereinbelow.

FIG. 1 shows a first embodiment of the present invention. FIG. 1 shows a light source unit 10, a camera 20 (e.g. a digital camera) or an area CCD (CMY), a macro lens 21, a film 22 as a subject to be scanned, and a personal computer 30 or a special controller.

The color area CCD mounted on the digital camera shown in FIG. 1 is provided with a complementary color filter or a primary color filter.

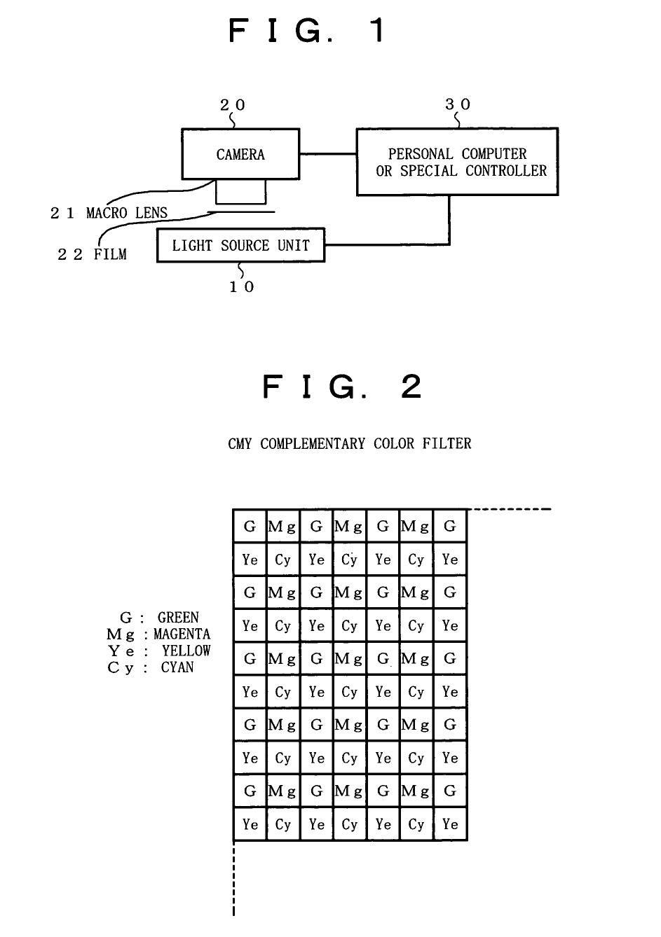

FIG. 2 is an explanatory view showing a typical CMY complementary color filter.

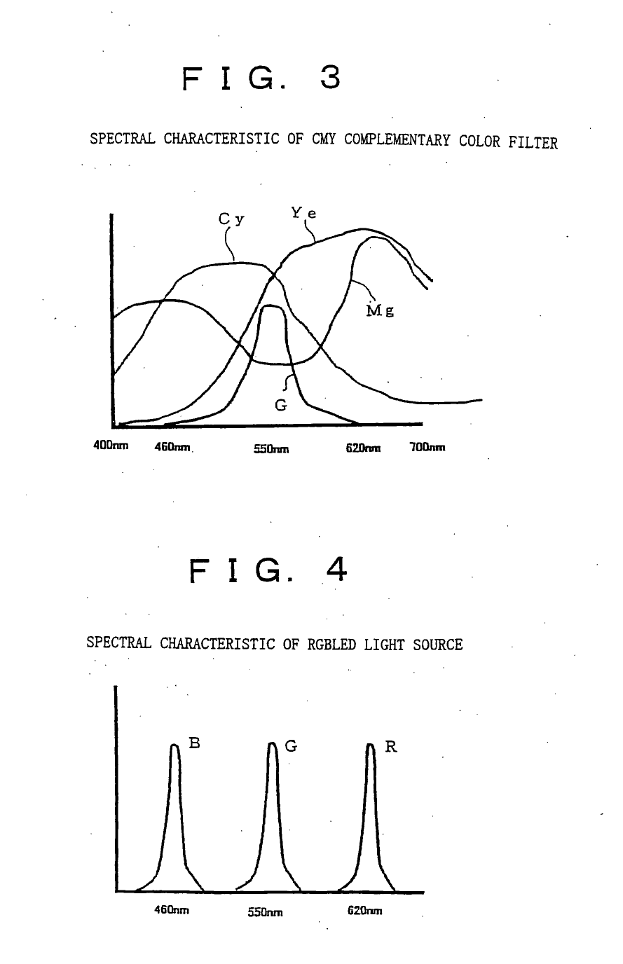

FIG. 3 is a view showing the spectral characteristics of the CMY complementary color filter shown in FIG. 2. In FIG. 2 and FIG. 3, “G” means green, “Mg” means magenta, “Ye” means yellow, and “Cy” means Cyan.

Furthermore, the light source unit 10 in FIG. 1 includes a three-color LED light source with R (red), G (green), and B (blue) light (hereinafter referred to as an RGBLED light source) having the spectral characteristics of narrow band.

FIG. 4 is a view showing the spectral characteristics of the RGBLED light source.

The color area CCD such as the digital camera, even if the complementary color filter shown in FIG. 2 is provided thereto, still has respective channel sensitivities with respect to the RGBLED light source having the spectral characteristics of narrow band. Meanwhile, the RGBLED light source is a light source suitable for the energy-saving trend, because of its high brightness, multiple colors, low drift, high adaptability, low heat emission, and no necessity of warming-up.

The RBGLED light source includes R color LEDs, B color LEDs, and G color LEDs which are alternately arrayed, for example. Moreover, the light source unit 10 includes a diffusing panel for allowing the light from the RBGLED light source to be emitted evenly, to prevent a film image, which is scanned by the color area CCD of the camera 20, from being granular (phenomenon that makes the image look rough). Furthermore, other than the diffusing panel, any member that allows the light from the RBGLED light source to be emitted evenly (for example, an optical waveguide) can be used.

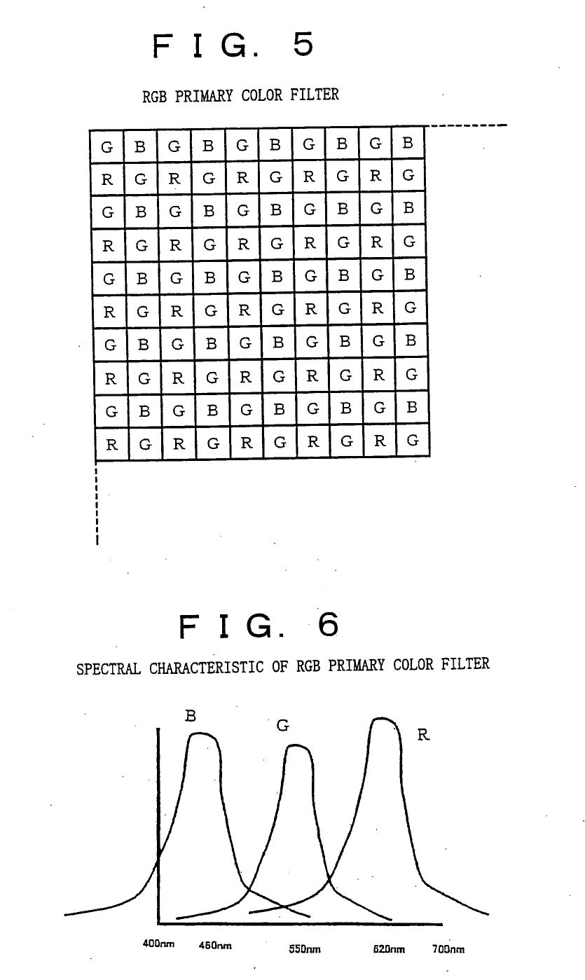

FIG. 5 is an explanatory view showing an example of the RGB primary color filter (Bayer array color filter). FIG. 6 is a view showing the spectral characteristics of the RGB primary color filter shown in FIG. 5. The color area CCD such as the digital camera still has the sensitivity with respect to the RGBLED light source having the spectral characteristics of the narrow band, even when it is equipped with the primary color filter as shown in FIGS. 5 and 6. Therefore, the present invention is effective both to the complementary color filters shown in FIGS. 2 and 3, and to the primary color filters shown in FIGS. 5 and 6.

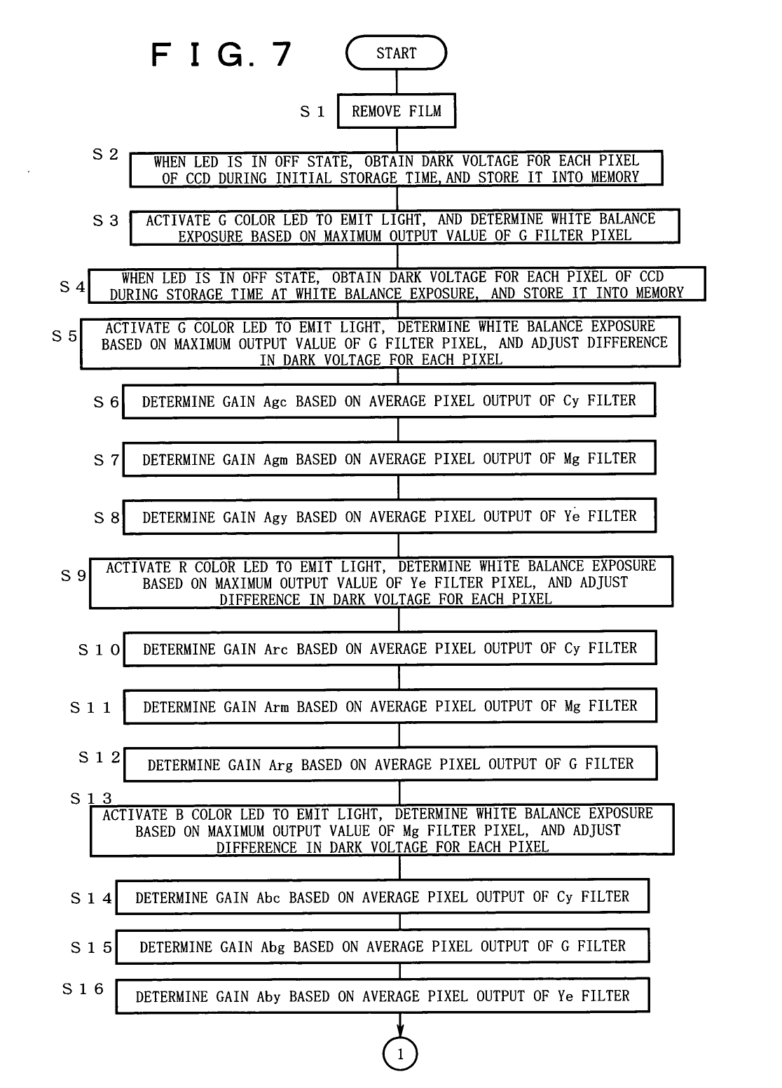

Hereinafter, an operation of the film image scanning system including the light source unit 10, the camera 20, and the personal computer or the special controller 30 as shown in FIG. 1 will be described with reference to the flowcharts as shown in FIGS. 7 to 9. Incidentally, a series of operations shown in the flowcharts are designed to be controlled according to programs stored in the personal computer or the special controller 30.

Meanwhile, when a system includes no personal computer or no special controller 30, the CPU of the camera 20 controls the system according to programs stored in the camera 20.

In the first embodiment as shown in FIG. 1, the personal computer or the special controller 30 sends out an exposure command to the camera 20 or a light-emission command to the light source unit 10, to perform the image scanning. Meanwhile, although the color area CCD is explained as equipped with the CMY complementary color filter shown in FIGS. 2 and 3, the color area CDD can be applied to the primary color filter as shown in FIGS. 5 and 6.

First, in step S1 as shown in FIG. 7, a film 22 as an original subject is removed. This film may be removed by an insertion/discharge mechanism to be provided in the film image scanning system, or may be removed manually by an operator.

In step S2, the RBGLED light source of the power source unit 10 is turned off, and a dark voltage during an initial storage time for each pixel of the color area CCD of the camera 20 is stored into a memory. Here, the initial storage time is determined in advance.

In step S3, the light source unit 10 activates only the G color LEDs to emit light. The camera 20 determines a value of the G color white balance exposure based on the maximum output out of the pixel outputs of the color area CDD at positions of the G filter. Meanwhile, it is well known that the exposure value is determined by the light-emitting time of the G color LEDs and the storage time of the color area CDD.

In step S4, the power source unit 10 is turned off, and the dark voltage for each pixel of the color area CCD during the storage time at the white balance exposure is stored into the memory. Therefore, the dark voltage obtained in step S2 is corrected.

In step S5, the light source unit 10 activates only the G color LEDs to emit light. The camera 20 determines a value of the G color white balance exposure based on the maximum output out of the pixel outputs of the color area CDD at positions of the G filter. What differs from the G color white balance obtained in step S3 is that the dark voltage has been corrected. The corrected dark voltage will be taken into consideration when gains Agc, Agm, and the like are determined in the following step S6 to S8, S10 to S 12, and S14 to S16.

In step S6, the gain Agc is determined based on the average pixel output at the Cy filter positions and the average pixel output at the G filter positions. Agc=(average pixel output at the G filter positions)/(average pixel output at the Cy filter positions).

Here, the gain Agc is a coefficient for correcting the luminous intensity of the G light to set it back to the original luminous intensity, since the luminous intensity of the G light is weakened because of the existence of the Cy filter when the light source unit 10 emits the G light. The gain Agc is multiplied by the pixel output at the Cy filter position, and has a function to normalize an output at the G light emission through the Cy filter.

In step S7, the gain Agm is determined based on the average pixel output at the Mg filter positions and the average pixel output at the G filter positions. Agm=(average pixel output at the G filter positions)/(average pixel output at the Cy filter positions).

Here, the gain Agm is a coefficient for correcting the luminous intensity of the G light to set it back to the original luminous intensity, since the luminous intensity of the G light is weakened because of the existence of the Mg filter when the light source unit 10 emits the G light. The gain Agm is multiplied by the pixel output at the Mg filter positions, and has a function to normalize an output at the G light emission through the Mg filter.

In step S8, the gain Agy is determined based on the average pixel output at the Ye filter positions and the average pixel output at the G filter positions. Agy=(average pixel output at the G filter positions)/(average pixel output at the Ye filter positions).

Here, the gain Agy is a coefficient for correcting the luminous intensity of the G light to set it back to the original luminous intensity, since the luminous intensity of the G light is weakened because of the existence of the Ye filter when the light source unit 10 emits the G light. The gain Agm is multiplied by the pixel output at the Ye filter position, and has a function to normalize an output at the G light emission through the Ye filter.

Additionally, in step S6 to S8, the following processes may be performed in order to obtain the gains Agc, Agm, and Agy more precisely. First, the G light is emitted a plurality of times. Then, average pixel outputs at the G filter positions, the Cy filter positions, the Mg filter positions, and the Ye filter positions are obtained. On the basis of the respective average outputs, the gains Agc, Agm, and Agy are determined. The number of times of emission of G light depends on the amount of noise, the number of pixels of the color area CCD, and the required precision. Specifically, it is determined as follows.

Cy(m) is set as a group of pixel outputs of the color area CCD corresponding to the Cy filter positions (m=1 to N). Likewise, Mg(m) is set as a group of pixel outputs of the color area CCD corresponding to the Mg filter positions (m=1 to N). Likewise, Ye(m) is set as a group of pixel outputs of the color area CCD corresponding to the Ye filter positions (m=1 to N). Likewise, G (m) is set as a group of pixel outputs of the color area CCD corresponding to the Ye filter positions (m=1 to N).

Gavn as an average of the G(m) is obtained:
Gavn={G(1)+G(2)+. . .+G(N)}/N

Cyavn as an average of the Cy(m) is obtained:
Cyavn={Cy(1)+Cy(2)+. . .+Cy(N)}/N
Mgavn as an average of the Mg(m) is obtained:
Mgavn={Mg(1)+Mg(2)+. . .+Mg(N)}/N
Yeavn as an average of the Ye(m) is obtained:
Yeavn={Ye(1)+Ye(2)+. . .+Ye(N)}/N

Gains Agc, Agm, and Agy are obtained by the following formulas:
Agc=Gavn/Cyavn
Agm=Gavn/Mgavn
Agy=Gavn/Yeavn

In step S9, the light source unit 10 activates only the R color LEDs to emit light. The camera 20 determines a value of the R color white balance exposure based on the maximum output out of the pixel outputs of the color area CDD at the Ye filter positions.

In step S10, the gain Arc is determined based on the average pixel output at the Cy filter positions and the average pixel output at the Ye filter positions. Arc=(average pixel output at the Ye filter positions)/(average pixel output at the Cy filter positions).

Here, the gain Arc is a coefficient for correcting the luminous intensity of the R light to set it back to the original luminous intensity, since the luminous intensity of the R light is weakened because of the existence of the Cy filter when the light source unit 10 emits the R light. The gain Arc is multiplied by the pixel output at the Cy filter position, and has a function to normalize an output at the R light emission through the Cy filter.

In step S11, the gain Arm is determined based on the average pixel output at the Mg filter positions and the average pixel output at the Ye filter positions. Arm=(average pixel output at the Ye filter positions)/(average pixel output at the Mg filter positions).

Here, the gain Arm is a coefficient for correcting the luminous intensity of the R light to set it back to the original luminous intensity, since the luminous intensity of the R light is weakened because of the existence of the Mg filter when the light source unit 10 emits the R light. The gain Arm is multiplied by the pixel output at the Mg filter position, and has a function to normalize an output at the R light emission through the Mg filter.

In step S12, the gain Arg is determined based on the average pixel output at the G filter positions and the average pixel output at the Ye filter positions. Arg=(average pixel output at the Ye filter positions)/(average pixel output at the G filter positions).

Here, the gain Arg is a coefficient for correcting the luminous intensity of the R light to set it back to the original luminous intensity, since the luminous intensity of the R light is weakened because of the existence of the G filter when the light source unit 10 emits the R light. The gain Arg is multiplied by the pixel output at the G filter position, and has a function to normalize an output at the R light emission through the G filter.

Furthermore, in step S10 to S12, in order to obtain the gains Arc, Arm, and Arg more precisely, the R light may be emitted a plurality of times to determine the gains Arc, Arm, and Arg based on the average pixel outputs at respective filter positions, in the same manner as in the above process (plural emissions of light) to precisely obtain the gains Agc, Agm, and Agy.

In step S13, the light source unit 10 activates only the B color LEDs to emit light. The camera 20 determines a value of the B color white balance exposure based on the maximum output out of the pixel outputs of the color area CDD at the Mg filter positions. In step S14, the gain Abc is determined based on the average pixel output at the Cy filter positions and the average pixel output at the Mg filter positions. Abc=(average pixel output at the B filter positions)/(average pixel output at the Cy filter positions).

Here, the gain Abc is a coefficient for correcting the luminous intensity of the R light to set it back to the original luminous intensity, since the luminous intensity of the R light is weakened because of the existence of the Cy filter when the light source unit 10 emits the B light. The gain Abc is multiplied by the pixel output at the Cy filter position, and has a function to normalize an output at the B light emission through the Cy filter.

In step S15, the gain Abg is determined based on the average pixel output at the G filter positions and the average pixel output at the Mg filter positions. Abg=(average pixel output at the B filter positions)/(average pixel output at the Mg filter positions).

Here, the gain Abg is a coefficient for correcting the luminous intensity of the B light to set it back to the original luminous intensity, since the luminous intensity of the B light is weakened because of the existence of the G filter when the light source unit 10 emits the B light. The gain Abg is multiplied by the pixel output at the G filter position, and has a function to normalize an output at the B light emission through the G filter.

In step S16, the gain Aby is determined based on the average pixel output at the Ye filter positions and the average pixel output at the Mg filter positions. Aby=(average pixel output at the B filter positions)/(average pixel output at the Ye filter positions).

Here, the gain Aby is a coefficient for correcting the luminous intensity of the B light to set it back to the original luminous intensity, since the luminous intensity of the B light is weakened because of the existence of the Ye filter when the light source unit 10 emits the B light. The gain Aby is multiplied by the pixel output at the Ye filter position, and has a function to normalize an output at the R light emission through the Ye filter.

Furthermore, in step S14 to S16, in order to precisely determine the gains Abc, Abg, and Aby, the B light may be emitted a plurality of times to determine the gains Abc, Abg, and Aby based on the average pixel outputs at the respective filter positions, in the same manner as in the above process (plural emissions of light) to precisely obtain the gains Agc, Agm, and Agy.

Furthermore, in this flowchart, the dark voltage at the R light and the B light emission is corrected by using the dark voltage at the G light white balance exposure (refer to steps S4 and S5). However, the dark voltage of each of the white balance exposure may be obtained and used when obtaining a plurality of gains of the R light and the B light.

Moreover, the respective gains determined in steps S6 to S8, S10 to S12, and S14 to S16 are stored as a table in the memory.

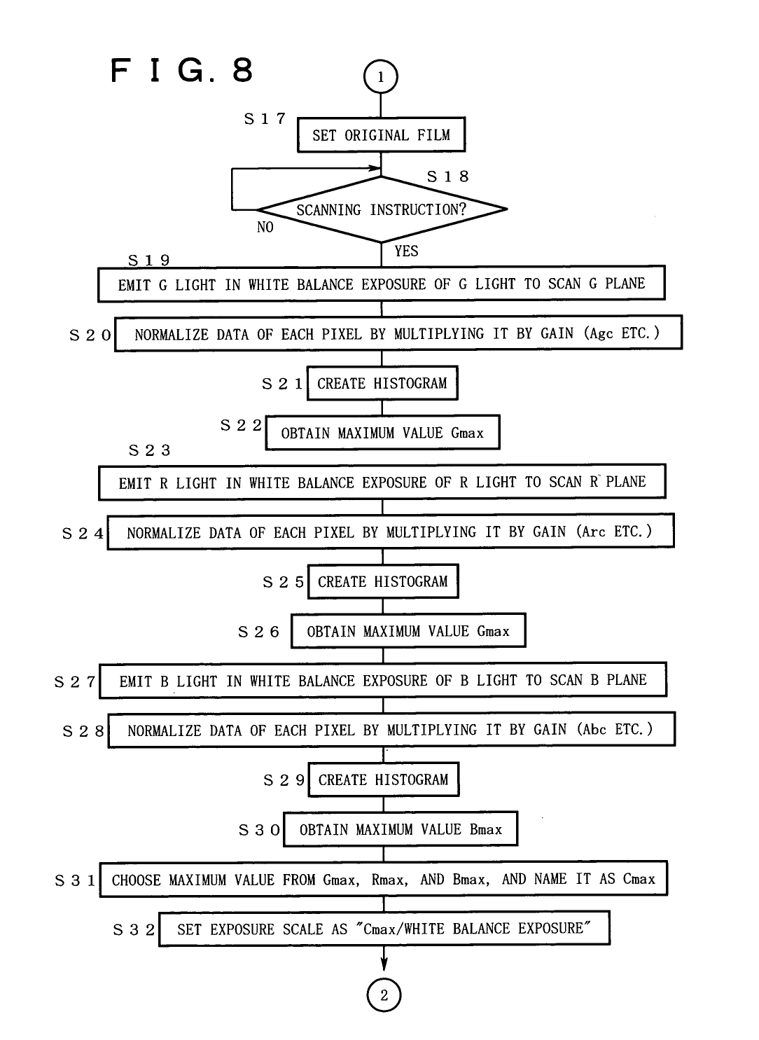

In step S17 as shown in FIG. 8, a film as an original subject is set. This film may be set by an insertion/discharge mechanism provided to the film image scanning system and also may be set manually by an operator.

In step S18, the system is in stand-by state for a scanning instruction. When the instruction is issued, the process moves forward to step S19.

In step S19, the light source unit 10 emits the G color light in the G light white balance exposure. At this time, G data is scanned as a G plane. The G data is output from all the pixels of the color area CCD equipped with the CMY complementary color filter as shown in FIGS. 2 and 3.

In step S20, each G data scanned is multiplied by each gain Agc, Agm, or Agy obtained in step S6 to S8 in accordance with a type of the complementary color filters (Cy filter, Mg filter, Ye filter). Such a process normalizes the amount of the G light which is transmitted through each of the complementary color filter such as G filter, Cy filter, Mg filter, and Ye filter.

In step S21, a histogram is created with regard to the normalized G plane obtained in step S20.

In step S22, the maximum value Gmax is obtained from the created histogram.

In step S23 to S26, the maximum value Rmax is obtained by performing the same processes in step S19 to S20 on R color.

In step S27 to S30, the maximum value Bmax is obtained by performing the same processes in step S19 to S20 on B color.

In step S31, the Cmax is determined by choosing the maximum value from Gmax, Rmax, and Bmax.

In step S32, an exposure scale is set to “Cmax/white balance exposure”. The exposure scale is obtained with respect to the R color light-emission, G color light-emission, and B color light-emission. Accordingly, the white balance exposure at the R color light emission, the white balance exposure at the G color light emission, and the white balance exposure at the B color light emission are used as the above-mentioned white balance exposure.

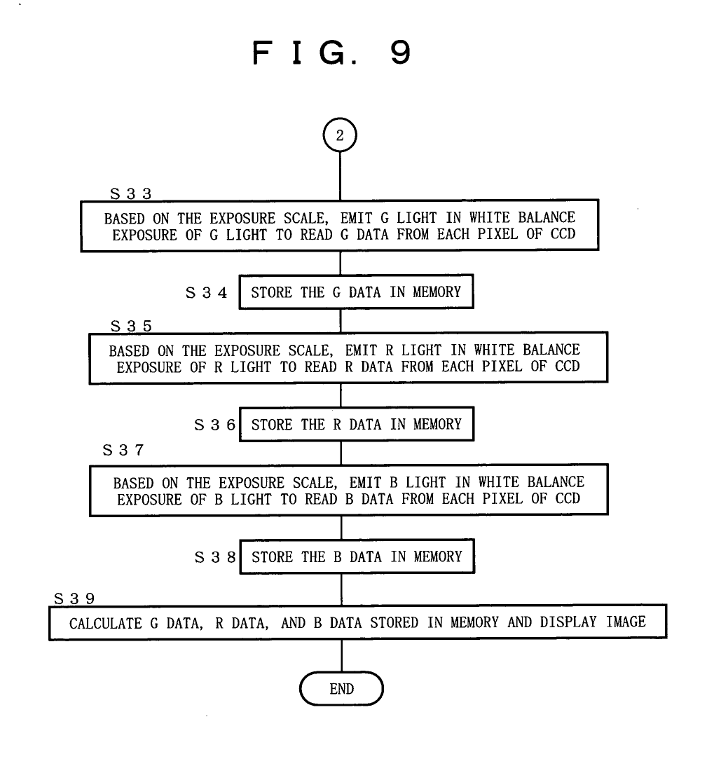

In step S33 as shown in FIG. 9, the G color light is emitted in the white balance exposure of the G color based on the obtained exposure scale with respect to the G color light-emission.

In step S34, the G plane data output from the color area CCD is stored in the memory.

In steps S35 and S36, the R light is emitted, and the same processes on the G light in steps S33 and S34 are performed with respect to the R light.

In steps S37 and S38, the B light is emitted, and the same processes on the G light in steps S33 and S34 are performed with respect to the B light.

In step S39, the G data, R data, and B data stored in the memory in steps S34, S36, and S38 are multiplied by the gains such as Agc, Agm, and Agy, respectively. The system combines the G plane, R plane, and B plane having been normalized by the multiplication, and displays the composite image. The image composition and display may be performed by the camera 20 shown in FIG. 1, or by the personal computer or the special controller.

Here, for example, assuming that each pixel data of the color area CCD is multiplied by the gain Agc to obtain the Cy data of the G plane. In this case, the pixel data at the Mg filter position may be saturated by multiplying the gain Agc (occurrence of non-linear area or excess of electric charge in the circuit). However, the well-known overflow drain mechanism can solve this problem easily.

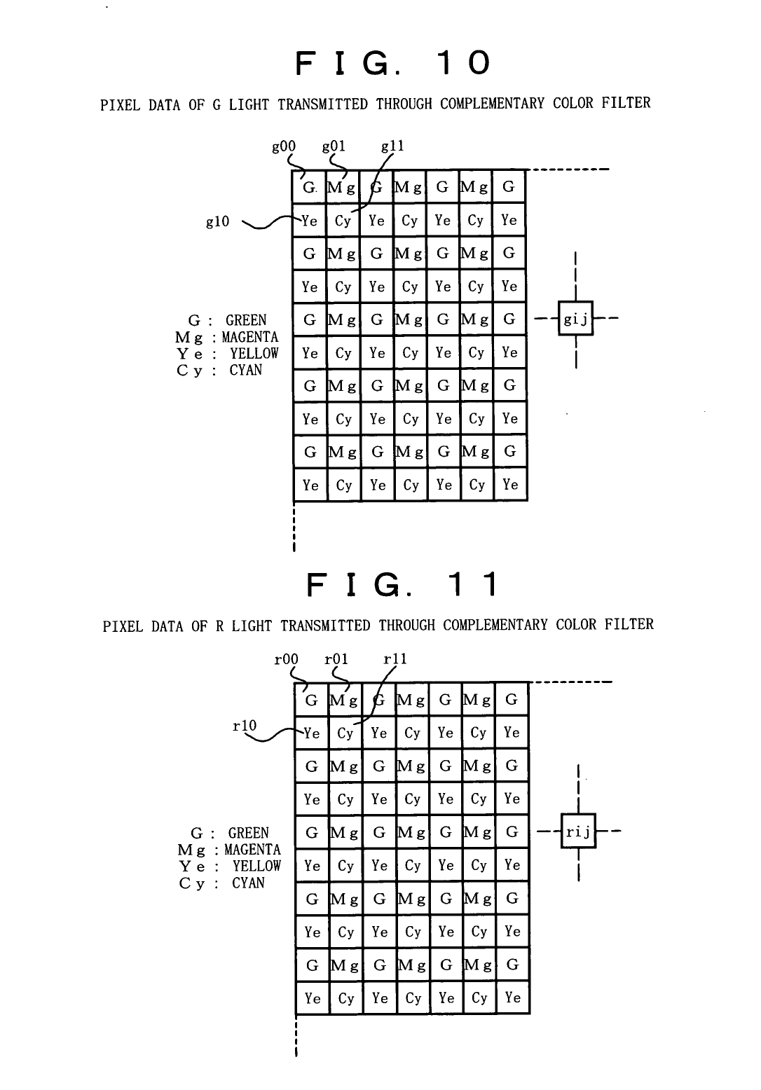

Next, the processes in steps S33, S35, and S37 will be described in detail. Here, the image composition in the case of using the CMY complementary color filter in the same manner as shown in FIG. 2 will be explained with reference to FIGS. 10 to 12.

First, the G color data reading shown in step S33 will be explained. The light source unit 10 emits the G light. Each pixel data output from the color area CCD and stored in the memory is multiplied by each gain (the Agy, Agm, and Agc) for correcting the difference in sensitivity. Because of that, the G color is normalized and all pixels of the color area CCD are set to be the G color data. In FIG. 10, gij indicates the G color data. Herein i means the number i row in the view shown in FIG. 10, and j means the number j column in the view shown in FIG. 10. As an example herein, the four pixels on the upper left corner of the complementary color filter shown in FIG. 10 will be described in detail.

Specifically, the G color is normalized according to the following formula:
g00=G00,
g10=Agy×Ye10,
g01=Agm×Mg01, and
g11=Agc×Cy11.

Here, g00, g10, g01, and g11 are obtained by correcting the light transmitted through the four filters (G, Ye, Mg, Cy) on the upper left corner of the complementary color filter by using the gains (Agy, Agm, Agc) for correcting the difference in sensitivity.

In the above formula, namely g00=G00, G00 is raw data output from the color area CCD. This is because the G color data g00 is the light transmitted through the G color filter and needs not be corrected.

In the above formula, namely g10=Agy×Ye10, Ye10 is raw data output from the color area CCD. In addition, Agy is the gain with respect to the yellow filter when the green light is emitted.

In the above formula, namely g01=Agm×Mg01, Mg01 is raw data output from the color area CCD. In addition, Agm is the gain with respect to the magenta filter when the green light is emitted.

In the above formula, namely g11=Agc×Cy11, Cy11 is raw data output from the color area CCD. In addition, Agc is the gain with respect to the cyan filter when the green light is emitted.

If all pixel outputs of the color area CCD are computed as above, the normalized G plane image with no difference in sensitivity can be obtained.

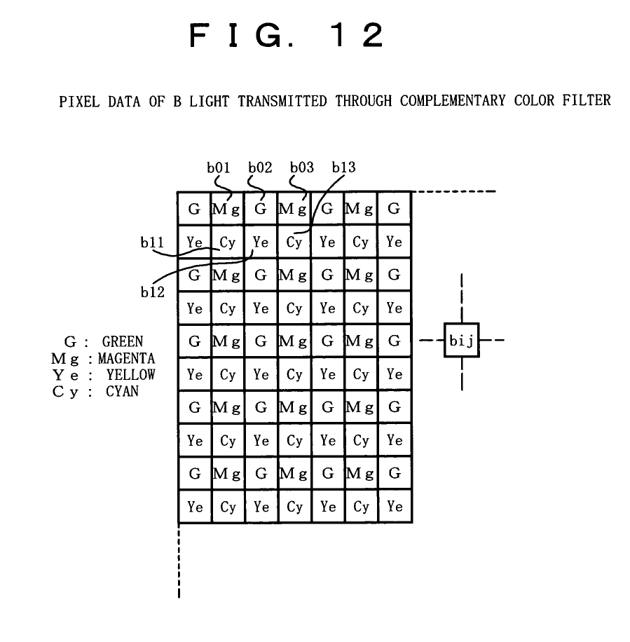

Next, the R color data reading shown in step S35 will be explained. The light source unit 10 emits the R light. Each pixel data output from the color area CCD is multiplied by each gain (Arg, Arm, Arc) for correcting the difference in sensitivity, to normalize the R color and to read in all pixels of the color area CCD as the R color pixel data. The R color data rij thus obtained is shown as follows. Herein i means the number i row in the view shown in FIG. 11, and j means the number j column in the view shown in FIG. 11. As an example, the four pixels on the upper left corner of the complementary color filter shown in FIG. 11 will be described in detail.

Specifically, the R color is normalized according to the following formula:
r00=Arg×G00,
r10=Ye10,
r01=Arm×Mg01, and
r11=Arc×Cy11.

Here, G00, Ye10, Mg01, and Cy11 are the raw data as in the case of the G light.

In addition, Arg is the gain with respect to the green filter when the red light is emitted. Arm is the gain with respect to the magenta filter when the red light is emitted. Arc is the gain with respect to the cyan filter when the red light is emitted.

The R plane image with no difference in sensitivity can be obtained by performing the above calculation to all the pixels of the CCD.

Next, the B color data reading shown in step S37 will be explained. The light source unit 10 emits the B light. Each pixel data output from the color area CCD is multiplied by each gain (Arg, Arm, Arc) for correcting the difference in sensitivity, to normalize it to the B color and to read in all pixels of the color area CCD as the B color pixel data. The B color bij thus obtained is shown as follows. Herein i means the number i row in the view shown in FIG. 1 2, and j means the number j column in the view shown in FIG. 11. As an example, the four pixels on the upper part of the complementary color filter shown in FIG. 12 (data b02, b12, b03, and b13) will be described in detail.

Specifically, the B color is normalized according to the following formulas.
b02=Abm×(Mg01+Mg03)/2,
b12=(Cy11+Cy13)/2,
b03=Abm×Mg03, and
b13=Cy13.

In the above formulas, Mg01, Mg03, Cy11, Cy13, and Mg03 are the raw data as in the case of the G light. Here, Mg01 and Mg03 are raw data obtained through Mg filters sandwiching G02. That is, the b02 is the B color pixel data obtained by processing the raw data (Mg01, Mg03) based on the transmitted light through the two Mg filters having a G filter therebetween. In addition, Abm is the gain with respect to the magenta filter when the B light is emitted. Here, since the left side of b01 (Mg01) shown in FIG. 12 corresponds to an end of the color area CCD, there is no Mg filter sandwiching a G filter. In this case, the raw data Mg01 can be used instead of an output of an Mg filter that does not exist.

Likewise, the b12 is the B color pixel data obtained by processing the raw data (Cy11, Cy13) based on the transmitted light through the two Cy filters having a Ye filter therebetween. The b13 utilizes the raw data Cy13 as it is.

Thus, by performing the processes shown in steps S33, S35, and S37 with respect to all pixels of the complementary color filters, the normalized G plane, R plane, and B plane can be obtained.

In steps S6 to S8, S10 to S12, and S14 to S16, the gains such as Agy, Agm, and Agc are obtained by averaging the output data obtained from respective pixels of the color area CCD. However, the present invention is not limited thereto. For example, the gains may also be determined by the color data (raw data) of each color pixel of the color area CDD based on the light transmitted through each of the Ye filter, Mg filter, and Cy filter, which are located in the center of the film image. They may also be determined for each pixel data of the Ye filter, Mg filter, and Cy filter.

Moreover, in steps S33 and S35, the gains such as Agy, Agm, and Agc are multiplied by respective pixel outputs from the color area CCD. In addition, in step s37, data of light transmitted through the color filters having low sensitivity is determined by an interpolation processing. This is to prioritize the scanning speed of the film image.

In the case of prioritizing an image quality (resolution, dynamic range, S/N, and sharpness) instead of the scanning speed, the processes in step S33 to S38 are repeated and the same color plane (R, G, B) is read in a plurality of times by a plurality of exposures. A plurality of data for each color (R, G, B) of each pixel obtained is finally combined, to produce an image with higher quality.

In the above embodiment, the light source unit 10 emits the R light, G light, and B light, and the influence of the complementary color filters is eliminated, thereby obtaining the normalized R plane, G plane, and B plane. However, the present invention is not limited thereto. The light source unit 10 may also emit infrared light (800 to 950 nm) to obtain a gain for each color filter at the infrared light emission. As a result, the normalized IR plane, i.e. the IR image with higher quality can be obtained. The light source unit 10 can emit infrared light by incorporating an IRLED. It is well known that defects of the film surface are corrected by using the infrared light. Quality of correction or the speed to perform the correction is affected due to a deviation between a defect location of a visual channel and that of an IR image.

If the defects of the film surface are corrected by using the infrared light, correction based on the data of real image (correction by the gains) becomes possible, without depending on the pixel interpolation processing. As a result, it is possible to correct the defects with high accuracy and high quality. However, in the case of correcting the defects of the film surface using the infrared light by the digital camera, since an infrared-light cut filter is incorporated in the optical system of the digital camera, it is necessary to review the amount and the exposure time of the infrared light.

Next, the light source unit 1 0 will be further described. As explained above, the light source unit 10 has LEDs of R, B, G, and IR serving as the light source. However, the present invention is not limited thereto. A fluorescent tube or a halogen light with an interference filter can also be adopted.

Then, the light source unit 10, as described above, has a diffusing panel to make the original film receive light evenly. However, the present invention is not limited thereto. The light source unit 1 0 may be equipped with a film holder in every film size (36 mm, Brownie, etc.) or a conversion lens.

In order to scan a color negative film, a color negative mode may be set in the light source unit 10. When scanning is performed under the color negative mode, the light source unit 10 raises up the amounts of B light and G light in consideration of an influence of the density of the orange color negative film base. As compared to the normal mode, the light source unit 10 emits the B light four times brighter, and G light twice brighter. Likewise, a color positive mode may be set in the light source unit 10 in order to scan a color positive film.

Furthermore, in step 33, each pixel data output from the color area CCD is multiplied by each gain (Agy, Agm, Agc) for correcting the difference in sensitivity, thereby normalizing the G color, and all pixels of the color area CCD is read in as the G color data. However, the processes in steps S33, S35, and S37 are not limited thereto. For example, the gains (Agy, Agm, etc.) with respect to respective filters can be divided into two groups according to the times of multiple shot and the exposure time.

Take the R light as an example. Given that when the R light is emitted, an output from the G filter is 3% with respect to the Ye filter. Therefore, the exposure scale of 33.3 times is necessary. In this case, by performing 32-time multiple shot, the G color data of each plane at each pixel position is added. Then, the exposure becomes 32 times. The remaining 1.3 times is reached by increasing the exposure 1.3 times. The sum of the data obtained by the 32-time multiple shot and the data obtained by increasing the exposure 1.3 times achieves the same effect as in the case where the exposure scale is multiplied by 33.3.

Thus, the R plane, G plane, and B plane with high resolution and high S/N can be obtained without using the gain or the interpolation processing, by the multiple shot, the adjustment of the exposure time, and a combination of both.

Meanwhile, since an increase in the amount of exposure causes an increase in the dark current, correction thereof is necessary. However, the problem of the dark current increase can be solved by the multiple shot adding the data obtained by performing a plurality of exposures.

According to the first embodiment, in spite of using the color area CDD that is hardware of the conventional digital camera etc, the system is able to greatly improve the resolution of film-scanned image and the dynamic range. Therefore, film images with high picture quality can be photographed using an existing digital camera.

In addition, in the first embodiment, it is described to exemplify a digital camera as a color area CCD. However, the present invention is not limited thereto. For example, a TV camera or the like with a color area CCD can also be used.

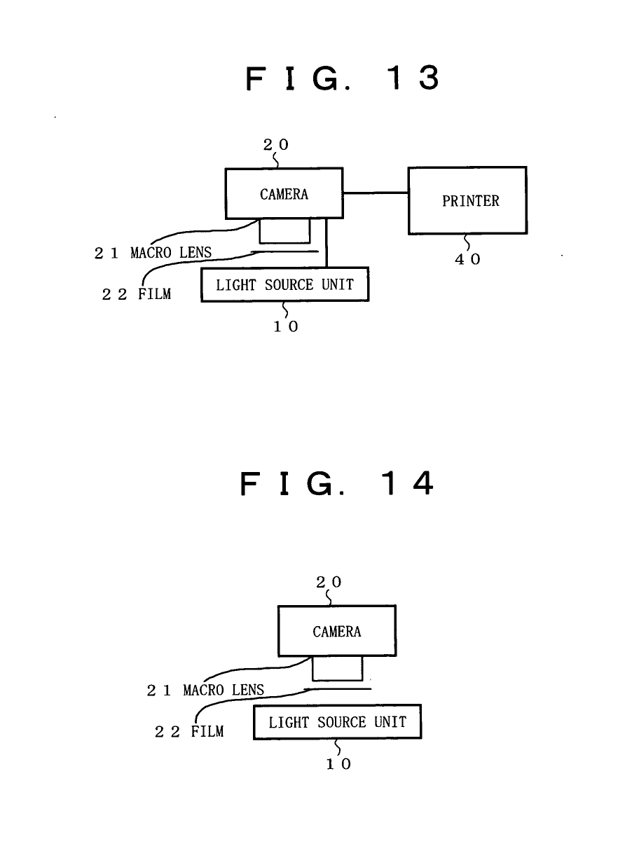

FIG. 13 is a view showing a second embodiment of the present invention. Components identical to those in the first embodiment will be referred to as identical numerals and the explanation thereof is omitted.

The second embodiment includes a light source unit 10, a camera 20, and a printer 40. The camera 20 executes the processes in step S1 to S39 (in FIG. 7 to FIG. 9) explained in the first embodiment according to the programs stored in the camera 20 by using CPU of the camera 20. The finally obtained image is stored into the internal memory (memory card for storing images etc.) in the camera 20. In addition, the monitor of the camera 20 displays the obtained film image. Furthermore, a user can print out the image using the printer 40.

As shown in FIG. 13, when the camera 20 is connected to the light source unit 10 through an exclusive or a general interface, the film-scanning mode is recognized to scan the film image. As described in the first embodiment, the light source unit 10 can be set in a normal mode, a color negative mode, and the like.

Further, the second embodiment with the printer 40 can also be achieved by connecting the printer 40 to, for example, the personal computer or special controller 30, or the camera 20 shown in the first embodiment (see FIG. 1).

According to the second embodiment, in the same manner as in the first embodiment, the resolution and the dynamic range of the film-scanned image can be improved greatly.

Consequently, film images with high picture quality can be photographed with an existing digital camera. Furthermore, a so-called digital minilab can be configured with low cost.

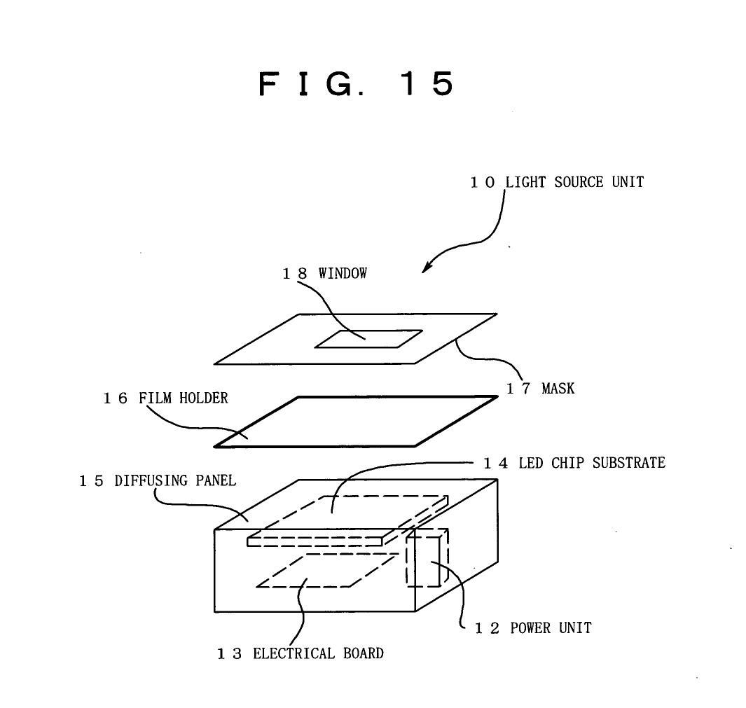

FIG. 14 is a view showing a third embodiment of the present invention. Components identical to those in the first embodiment shown in FIG. 1 are referred to as identical numerals and the explanation thereof is omitted.

The third embodiment includes a light source unit 10 and a camera 20. The camera 20 executes the processes in step S1 to S39 (in FIG. 7 to FIG. 9) explained in the first embodiment according to the programs stored in the camera 20 using CPU of the camera 20. The finally obtained image is displayed on the monitor and stored into the internal memory (memory card for storing images etc.).

The process of the third embodiment will be described briefly as follows.

The light source unit 10 is equipped with a white balance mode (color negative mode and normal mode), an R lighting switch, a G lighting switch, and a B lighting switch.

The light source unit 10 is set to the white balance mode and emits respective illumination light beams. In this case, when the amount of each color light for the white balance is determined in advance, light of each color is emitted simultaneously with the required amount of light emission. In the case of the color negative mode, the white balance exposure with increased amount of the blue light and the green light is performed.

The camera 20 photographs the above-mentioned white balance light.

Next, a film 22 is set in place.

Next, the light source unit 10 emits R light and the camera 20 photographs the film.

Next, the light source unit 10 emits G light, B light, and IR light in sequence and the camera 20 photographs the film.

Next, in the camera 20, the image composite processing is performed based on the R light, G light, B light, and IR light. Dedicated composite driver software stored in the memory of the camera 20 controls this process.

Next, the composite image data is displayed on the monitor of the camera 20.

According to the third embodiment, film images with high picture quality can be photographed using an existing digital camera.

If the camera 20 is connected to a printer, the film image can be printed thereby as in the second embodiment.

Hereinafter, the light source unit 10 will be described.

FIG. 15 is an explanatory view showing an embodiment of the light source unit 10.

As shown in FIG. 15, the light source unit 10 includes a power unit 12, an electrical board 13, an LED chip substrate 14, and a diffusing panel 15. An original film is held by a film-holder 16. In addition, on the film-holder 16 there is a mask 17 with a window 18. The mask 17 prevents the light, which is not transmitted through the film, from entering into the macro lens of the camera 20. As described above, the diffusing panel 15 allows the light from the LED chip substrate 14 to be emitted evenly, to prevent the film image scanned by the color area CCD of the camera 20 from being granular (phenomenon that makes the image looks rough). Moreover, besides the diffusing panel, any member that is able to allow the light from the LED chip substrate 14 to be emitted evenly may be used.

The electrical board 1 3 receives an electric power from the power unit 12 to make the LED chip substrate 14 emit light.

On the LED chip substrate 14, for example, RLEDs, GLEDs, and BLEDs are arrayed regularly, such as in staggered array or Bayer Array. In addition, there is a case where the LED chip substrate 14 includes the IRLEDs (infrared light), as described above. The camera 20, or the personal computer or the special controller 30 instructs the electrical board 13 to activate LEDs simultaneously or selectively.

The color balance of the light source unit 10 in the case of the color positive film (in a case other than the color negative film) is normalized to the white balance by the base density of the color positive film. In other words, the base density of the color positive film is set to the digital value in full span. Herein the base density means a density closest to the white color in the film images.

The color balance of the light source unit 10 in the case of the color negative film is set to have a power ratio whereby an orange base density of the color negative film is normalized to the white balance. Specifically, in the same manner as in the color negative mode, the white balance light with an increased amount of the blue light and the green light is emitted.

Therefore, the power source unit 10 changes the number and the power of light emission of each color LED depending on situations where a color positive film is photographed and a color negative film is photographed.

A general white light source which does not have the narrow-band spectral characteristics as shown in FIG. 4 can be used as a light source of the power source unit 10. In this case, the white light source is covered with a proper RGBIR filter, and the R plane, G plane, B plane, and IR plane are read in by a digital camera. Consequently, the same effect as in the first embodiment and the like can be achieved. Furthermore, the defects of film surfaces can be corrected by using the infrared light. As the above-mentioned filter it is preferred to use an interference filter or the like, and a band-pass (notch) filter having a half-width of approximately 60 nm.

In the description above, a digital camera or a TV camera with a color area CCD is used as examples. However, the present invention is not limited thereto and can also be applied to an image scanning apparatus and the like using a color linear CCD.

In the color linear CCD, color filters such as G, Cy, Mg, and Ye are arrayed in a certain arrangement (for example, in a staggered form) for each pixel of the CDD arrayed in a line. In this case, on a main scanning for one line, the film image is scanned in the same manner as in the first embodiment by emitting each of the G light, R light, and B light. Then, the light-emitting unit or the film is moved to a sub scanning line to scan the film image of the next line. Thus, the color linear CCD can scan film images with a greatly improved resolution and dynamic range, as in the case of the color area CCD.

Further, as mentioned above, it is described that the light source unit 10 includes as the light source the LEDs of R, B, G, and IR, but the present invention is not limited thereto. A fluorescence tube or a halogen light with an interference filter can also be used instead.

1. A film image scanning system comprising:
a light source unit for scanning a film, the unit emitting light of a plurality of narrow bands toward a film as a single band or in a combination thereof; and
an image input apparatus scanning the light transmitted through the film with a color CCD, producing an image plane of each color of the light based on data from the color CCD where each color of the light has been subjected to a sensitivity correction, and producing a film image by combining the respective image planes produced.

2. The film image scanning system according to claim 1, wherein
the image input apparatus includes a control unit controlling operations of the light source unit and the image input apparatus itself.

3. A film image scanning system comprising:
a light source unit for scanning a film, the unit emitting light of a plurality of narrow bands toward a film as a single band or in a combination thereof;
an image input apparatus scanning the light transmitted through the film with a color CCD, producing an image plane of each color of the light based on data from the color CCD where each color of the light has been subjected to a sensitivity correction, and producing a film image by combining the respective image planes produced; and
a controller connected to the light source unit and the image input apparatus so as to control operations of the light source unit and the image input apparatus.

4. The film image scanning system according to claim 1, wherein the color CCD is a color area CCD.

5. The film image scanning system according to claim 3, wherein the color CCD is a color area CCD.

6. The film image scanning system according to claim 1, wherein the color CCD is a color linear CCD.

7. The film image scanning system according to claim 3, wherein the color CCD is a color linear CCD.

8. The film image scanning system according to claim 1, wherein the image input apparatus is a digital camera.

9. The film image scanning system according to claim 3, wherein the image input apparatus is a digital camera.

10. The film image scanning system according to claim 1, wherein the image input apparatus is a TV camera using a color area CCD.

11. The film image scanning system according to claim 3, wherein the image input apparatus is a TV camera using a color area CCD.

12. The film image scanning system according to claim 1, wherein
the light source unit emits infrared light singly or in combination with another narrow-band light.

13. The film image scanning system according to claim 3, wherein
the light source unit emits infrared light singly or in combination with another narrow-band light.

14. The film image scanning system according to claim 1, wherein
the output from the color CCD is multiplied by a gain which is in accordance with the color of the light emitted from the light source unit and a type of a filter provided in the color CCD.

15. The film image scanning system according to claim 3, wherein
the output from the color CCD is multiplied by a gain which is in accordance with the color of the light emitted from the light source unit and a type of a filter provided in the color CCD.

16. The film image scanning system according to claim 1, wherein the gain is stored as a table in a memory.

17. The film image scanning system according to claim 3, wherein the gain is stored as a table in a memory.

18. The film image scanning system according to claim 1, wherein
in accordance with the color of the light emitted from the light source unit and a type of a filter provided in the color CCD, an amount of exposure is adjusted.

19. The film image scanning system according to claim 3, wherein
in accordance with the color of the light emitted from the light source unit and a type of a filter provided in the color CCD, an amount of exposure is adjusted.

20. The film image scanning system according to claim 1, wherein
light emission and exposure are performed a plurality of times for each color of the light in accordance with the color of the light emitted from the light source unit and a type of a filter provided in the color CCD.

21. The film image scanning system according to claim 3, wherein
light emission and exposure are performed a plurality of times for each color of the light in accordance with the color of the light emitted from the light source unit and a type of a filter provided in the color CCD.

22. The film image scanning system according to claim 1, further comprising a printer printing the image having been read in by the image input apparatus.

23. The film image scanning system according to claim 3, further comprising a printer printing the image having been read in by the image input apparatus.

24. A light source unit for scanning a film, comprising:
a light-emitting unit emitting light in a plurality of colors;
a diffusion device which diffuses the light from the light-emitting unit evenly toward a film; and
a film holder holding the film.

25. The light source unit for scanning a film according to claim 24, wherein the light-emitting unit includes one of
LEDs each having a different color (including an LED emitting infrared light),
a fluorescent tube with an interference filter, and
a halogen tube with an interference filter.

26. The light source unit for scanning a film according to claim 24, further including a color negative mode for performing white balance exposure with an increased amount of light emission of green and blue colors out of the colors of the emitted light.
